(19) United States
(12) Patent Application Publication
(10) Pub. No.: US 2013/0132167 A1
(43) Pub. Date: May 23, 2013

(54) Cloud Based Parking Management System and Method

(71) Applicant: Wirelesscarpark.com, Inc., Plainville, CT (US)

(72) Inventors: Joshua M. Krug, West Hartford, CT (US); John W. Beyer, Plantsville, CT (US)

(73) Assignee: WIRELESSCARPARK.COM, INC., Plainville, CT (US)

(21) Appl. No.: 13/677,445

(22) Filed: Nov. 15, 2012

Related U.S. Application Data
(60) Provisional application No. 61/562,171, filed on Nov. 21, 2011.

(51) Int. Cl. G07B 15/02

(52) U.S. Cl. CPC G07B 15/02
USPC 705/13

(57) ABSTRACT

A system and method for many administrators to financially manage the parking of vehicles at parking locations where attendants record toll transactions with portable wireless devices, through a common, cloud-based central computer server. Each local transaction recording device, such as a hand-held PDA, stores the data for multiple toll transactions until confirming that a global communications connection meets a threshold level of quality, before transmitting the data batch-wise to the central server. In this way, data from hundreds if not thousands of toll transactions can be temporarily stored until reliably transmitted to the central server. The remote server is preferably under the control of a single service company that contracts with multiple parking management companies and operators to record transaction information and provide reports associated with an effectively unlimited number of parking lot locations and portals.

### RELATED APPLICATION

Priority is hereby claimed under 35 U.S.C. §119(e), from Provisional Application No. 61/562,171 filed Nov. 21, 2011 for, “Cloud Based Parking Management System and Method”.

### BACKGROUND

The present invention relates to the record keeping associated with calculating and collecting a vehicle parking toll at one or more portals or gates of least one parking lot location, commonly referred to as “revenue control”.

The parking industry includes parking lot owners or lessees, lot operators who can be the owners or a management company hired by the owners, distributors of parking management systems that the owners or operators purchase or lease for installation and use at the lots, and management system developers who supply the distributors. A number of large management companies operate thousands of lots, with each lot having specific requirements as to whether a toll booth and/or gate control the portal, toll differences for various categories of vehicles or other status, form of ticket to be printed and given to the vehicle driver upon payment of the toll, etc. The management companies and operators require that the toll transactions be recorded and stored in digital form in a manner whereby various usage and financial reports can be generated.

For so-called “event parking”, it is common that an attendant with a hand held device, stands alongside a vehicle at the portal and enters transaction information, collects the toll, and prints a ticket, and then permits the vehicle to enter the lot. A number of parking management systems are available for handling event and other parking facilities. Many such systems rely on so-called “wireless” communication (such as wi-fi) in real time between the hand held devices and a local server. Some systems rely on real time communication between the hand held devices and a local or remote central server, over a global communications network (e.g., Internet).

All these systems have at least one fundamental deficiency. In the case of local wireless communication, the range of signal reception is short so for large lots with many portals an extensive network of cables must be laid from an environmentally controlled server to antennae near the respective portals. This type of infrastructure can perhaps be efficiently installed when a large new parking lot is under construction, but is quite costly to back fit into existing large lots. In the case of Internet communications, the quality of the connection can vary over the course of hours or even minutes, whereby even an occasional failure can require restart of the server and delays at the toll portal. An interrupted communication from even one hand held device can disrupt operations of an entire lot having multiple portals or a system of lots that rely on the same server.

### SUMMARY

The present invention overcomes these deficiencies by providing a more reliable transmission of toll transactions over a global communications network, from the attendant to a remote central server.

This improvement in reliability is based on the local transaction device, such as a hand-held PDA, storing the data for multiple toll transactions until confirming that the global communications connection meets a threshold level of quality, before transmitting the data to the central server. In this way, data from hundreds if not thousands of toll transactions can be temporarily stored until reliably transmitted to the central server.

The remote server is preferably under the control of a single service company that contracts with multiple parking management companies and operators to record transaction information and provide reports associated with an effectively unlimited number of parking lot locations and portals.

In simplest form, the present system handles a small subset of revenue control, in which a customer buys a ticket or uses a pre-purchased pass to enter the parking location or lot through a toll portal staffed by an attendant. However, the novel features can be incorporate into more comprehensive parking revenue control systems at, e.g., parking garages, hotels, airports, etc.

A preferred system and method are described for an administrator to financially manage the parking of vehicles at a location where an attendant records toll transactions with a portable wireless device at a toll portal. A central computer processing server is situated remote from the location of the parking lot location. The attendant has a portable device which accepts manually entered input data according to preestablished categories of vehicle or driver, such as type of vehicle, type of vehicle driver, number of vehicle occupants, and area within the location where the vehicle is authorized to park.

The portable device includes
(i) a database of price data associated with a respective at least one of the input data,
(ii) a processor responsive to the input data and the price database for generating print instructions for a ticket showing the amount of the toll transaction,
(iii) a cache memory where data for each of a plurality of ticket transactions is stored, and
(iv) a wireless communication module for transmitting the data in the cache memory to a transaction program in the remote server over a connection to a global communications network, in a batch process after, e.g., a preset time interval, and/or after confirming that the network connection satisfies a threshold level of quality.

An administrative computer is connectable over a global communications network to an administration program in the remote computer, by which the administrator can enable portable devices for use in recording toll transaction and communicating with the central server, and obtain reports on the transactions

The mobile handheld computer is entirely self-contained. All transaction processes are handled locally. From startup, logon, shut down, and all functions in between, the system operates whether or not an Internet connection is available. Subsequent to the local data storage, there is a separate process which continually (on a repeat schedule) synchronizes data to the remote data center when a quality Internet connection is available.

The independent architecture allows the system to function over far less stringent data connections than traditional systems. The system can support both cellular and wireless connections (offline and no connection at all) to the remote data center.

Credit card processing is handled without a server dedicated to the facility for data storage and/or processing credit cards. With the present system the handheld itself connects directly to the credit card company to process the card.

In addition, the system is far easier to maintain than other systems by including a built in update function that will download and install application updates and upgrades at regular intervals as initiated by the administrative computer or the central server to the devices without the intervention of an attendant or engineer.

As another advantageous feature of the system and method, each hand held device can be reconfigured to reflect changes in location, rates, passes, or other conditions that may vary from lot to lot, season to season, or event to event, while the devices are in the field, over the global communications network. Preferably, each device is configured to synchronize with the central server on a preset schedule according to which the toll transaction data are synchronized and any configuration changes are made.

The inventive system offers many advantages to parking facility owners or managers. All configuration changes for multiple devices at multiple locations are specified in an administrative computer for delivery through a website operated by the service provider, whereby all of the devices can thus be reconfigured in the field without the need for docking with the administrative computer or physical handling of the devices. The toll transaction data are stored on the central server and reports are accessible to the administrator at the administrator's computer via access to the same website. The administrator computer does not need any special program but only access to the global communications network using a conventional browser. For this reason, the operator or owner can use any computer for communicating with the service provider, so long as the proper identification and password are used. The entire system is more robust, in that the data associated with each toll transaction are stored in the hand held device and not subject to problems that may arise in the communication systems at a particular location (such as between the hand held and a local computer) or temporary disruptions in access to the global communications network (as might arise in the event of temporary power outage) because data for many toll transactions can be stored in the device until a quality connection is made with the central server whereupon the previously unsynchronized transaction data are uploaded in a batch process.

The system utilizes modern Bluetooth printing capabilities. The handheld prints customer receipts itself over a Bluetooth connection rather than asking a local server to handle printing.

The system also has the capability to lift gate arms directly from the portable device, without the need to interface with other parking management software.

### BRIEF DESCRIPTION OF THE DRAWING

Salient aspects of the invention will be described with reference to the accompanying Drawing, in which:

FIG. 1 is a schematic representation of one system embodiment in which a plurality of hand-held input devices at two different parking locations transmit parking transaction data over a global communications network to a central server that is accessible to an administrator for downloading transaction information relating to all the locations;

FIG. 2 shows the relationship of various computer-related hardware for implementing the data acquisition and transmission associated with FIG. 1; and

FIG. 3 is a flow diagram of the computer program logic associated with the system of FIGS. 1 and 2.

### DETAILED DESCRIPTION

### 1. Overview

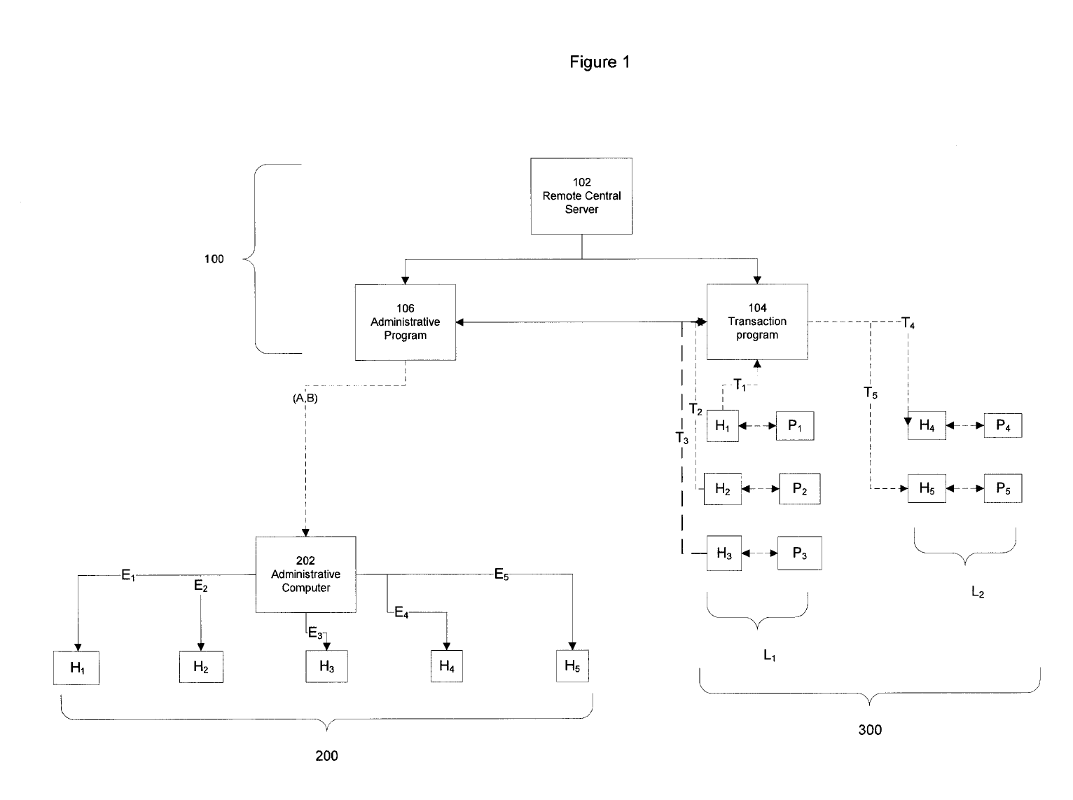

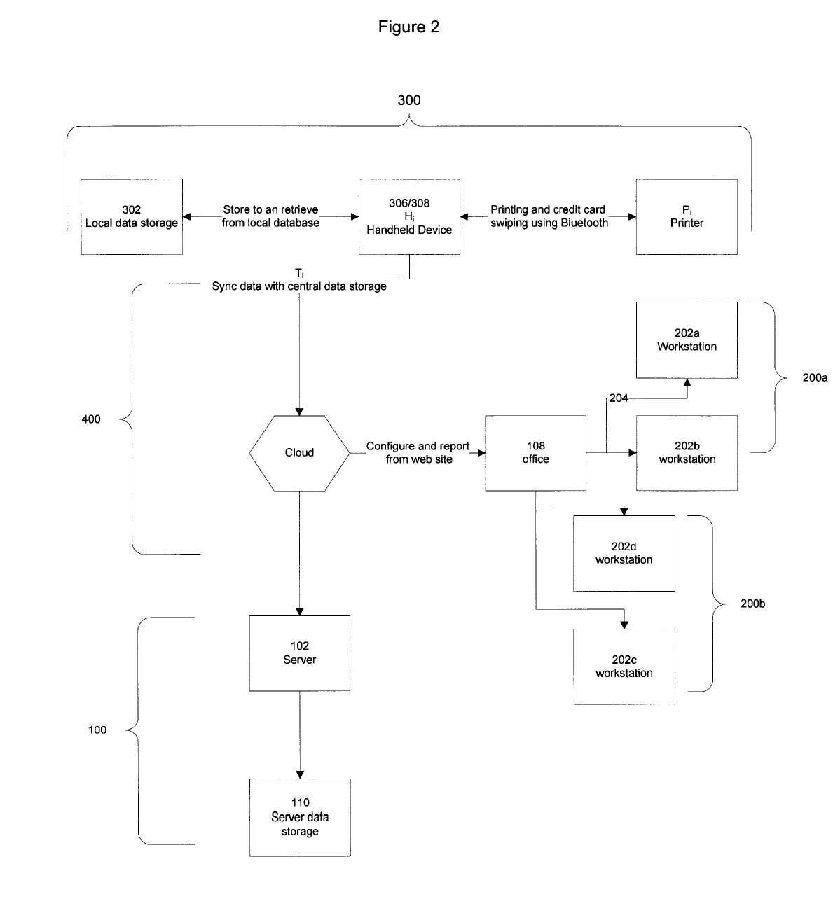

As represented in FIGS. 1 and 2, the main actors are a service provider 100 with remote computer server 102 accessible in the “cloud”, parking lot manager 200 who has an administrative computer 202 at any convenient local office, and parking lot attendants 300 who collect the tolls and record the transactions on hand-held PDA's or the like H1-H5 . . . Hn with associated printers P1 . . . P5 . . . Pn for tickets. The system accommodates many hand held devices H1, H2, H3 at a given location such as L1 as well as multiple locations such as L2 with H4 and H5 (and more generally Hx at Lz), because all transaction related transmissions T1 . . . T5 . . . Tn (generally, Ti) are from the hand held devices H to the central computer at 102 over a global communications network, such as gprs/cellular technology as well as wi-fi.

A key feature is that each hand held device Hi stores multiple vehicle parking transaction data and periodically when a good Internet or similar connection is confirmed, transmits Ti the accumulated data in batches to the transaction program 104 at central server 102 via the cloud 400 (not to the local administrative computer). Management accesses the administrative program at the remote computer 102 for obtaining reports and the like (A). In the embodiment of FIG. 1, the administrator can interact with the central server 102 for downloading authorization data and updates (B) from the central computer 102 and then preparing each hand held Hi for use at the various locations L1, L2, . . . Ln (generally, Li) by loading each hand held device with the authorization data for the respective locations and general updates to enable (E1 . . . E5 . . . En) the hand held devices to wirelessly communicate with the central computer via Ti at the locations.

The hand held devices Hi never communicate transaction information with the administrative computer 202, so no local server with antennae or modems are used and therefore the associated cost of hardware and cabling at each parking location and the limited range of wireless hand held communications devices are avoided.

### 2. Computers

The application programs for the system and method are delivered or installed by the service provider 100. The device transaction program software resides in each device Hi, and defines and executes instructions for authorizing use, data acquisition, navigation, logic operations, data storage, and wireless communications between the device Hi and the central server 102. Each device is a portable wireless communications device approved by and registered with service provider 100, containing and capable of executing the device transaction program.

The service provider's central server 102 is in a computer system operated by or for the service provider 100 which communicates with devices Hi and the administrator computer 202 over a global communications network 400 such as the Internet. The central server 102 contains a central transaction program 104 for receiving and processing data from the portable devices Hi, and a central administration program 106 for two way communication with the administrative computer 202, whereby the administrator 200 can manage the utilization of devices and download reports. The administrator would typically be located at an office on or off the site of the parking location, from which he or she manages the assignment of attendants and devices to particular lots or portals and accesses the administrator program 106 at the service provider's remote server. The central administration program 106 is accessible 204 with log on and password control through a web site 108 operated by the service provider.

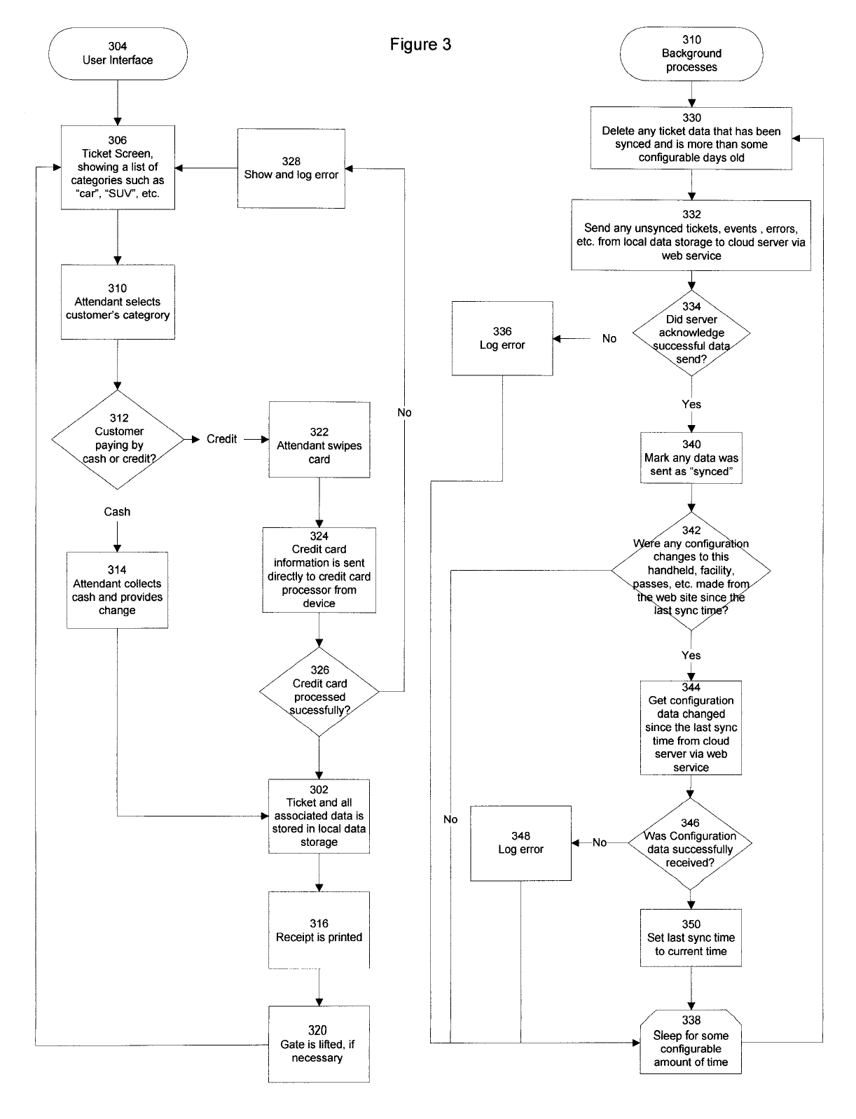

In FIG. 1, one administrator 200 oversees the operators 300 at two locations L1 and L2. FIG. 2 is a hybrid representation, showing an individual hand-held wireless device Hi and four administrators 200a, b, c and d, each overseeing a respective different collection of operations 300a, b, c and d, with each operation having any number of locations Li and any number of devices Hi. The administrators 200a-200d can be related business entities, or entirely independent. In FIG. 3, a first administrator 200a (e.g., parking management company) manages two parking locations via two administrator computers 202a, 202b while a second administrator 200b (e.g., parking lot owner) manages two other parking locations via another two administrator computers 202c, 202d. All communicate with the service provider 100 through the same web site 108. In this embodiment, authorizations and updates for the hand held devices Hi are implemented directly from the central server 102.

Thus it should be understood that each device Hi has a readily implemented combination of hardware and remotely programmable software for storing a database of price data associated with at least one vehicle category and accepting manually entered input data associated with each category. A processor is responsive to the input data and the price database for generating print instructions for a ticket showing the amount of the toll transaction. A memory stores data for each of a plurality of ticket transactions. At selected time intervals or other intermittent or time-spaced conditions, a wireless communication module simultaneously transmits stored data for a plurality of ticket transactions to a transaction program in the remote server over a connection to a global communications network.

Each device Hi is activated when it has been designated by the administrator 200 through the service provider site 108 and enabled by the administrator or central server, to perform the operational functions associated with a toll transaction. The administrative computer 202 performs this function while connected to the central administration program 106, where the relevant data are stored 110 and logic executed.

### 3. Functionality

The system provides functionality in the two modes of operations and management. The administrator 200 has the sole authority to utilize the management functionality and to select and supervise attendants who will utilize the devices to record toll transactions.

Each device Hi is capable of storing data locally 302 regarding multiple transactions and automatically uploading the data Ti periodically to the central server 102 via program 104, but the attendants need not have the capability to initiate interactive communications with the central server.

The administrator 200 has interactive communications capability with the central server 102, using any computer or other device 202 which is capable of communicating over the same global communications network 400. All system-specific computer programs necessary for the administrator to perform the management functions reside on the central server 102 or other remote computing facility.

Preferably, the central server 102 is under the control of a service provider 100 who contracts with a management company customer, such as 200a. This relationship is preferably based on the customer purchasing and owning the hardware indicated at 200 and 300, but with the service provider 100 directly or indirectly loading the hardware with the required system-specific software, and the customer paying a monthly license fee or royalty for each activated device Hi. Moreover, the contract could provide that a given customer owns any number of devices Hi that are capable of recording toll transactions, but pays a fee for any given month based only on the subset of devices that have been activated during that given month.

The customer can use any activated device at any parking location at any time. The assignment of a particular device to a particular parking location at a particular time is defined by the administrator 200a making the appropriate selections according to the user interface 102, 106, 108, accessed by the administrator through the service provider site. The administrator can also obtain reports and request deactivation of particular devices through this site. Although the administrator computers 202a-202d and central computer communicate through the cloud 400, the administrator computers preferably do not communicate directly with the devices Hi, but rather rely on the communications path from 202 to 106 to Hi via Ti.

The service provider 100 can retain the capability of (a) locking down each device Hi so that it can perform no function other than implementing the system; (b) activating or deactivating individual devices Hi according to instructions provided by the administrator 200; (c) remotely installing revisions or updates to the software in the devices Hi; and (d) monitoring authorized use of the devises Hi pursuant to each customer's contract.

The logic implemented by computer code in each hand-held device Hi and the transaction program 104 as depicted in FIGS. 1 and 2, is shown in FIG. 3.

4. Toll Transactions (FIGS. 1, 2 and 3)

Toll transactions involve user interface logic 304 in the device Hi by which the parking attendant navigates through a screen display 306 by touching hard or soft buttons 308 or the like. At the same time, background processing 310 between the device Hi and the transaction program 104 at the service provider 100, is not evident or monitored by the attendant at 300 or the administrator at 200.

Ticket Printing

i. Cash
a. User selects the customer category 310 (such as in-state, out of state, senior citizen, single vs. multiple vehicle occupants, etc.) and the display defaults to or a selection is made at 312 for cash.
b. When the cash is paid 314 the information is stored on the device local database 302 and a ticket is printed 316 by an integral printer or by a proximate printer Pi over a Bluetooth connection 318.
c. If the lot is gated, the gate is lifted 320.
d. No connection is made with a local or the central server.

ii. Credit
a. User selects the customer category 310 (such as in-state, out of state, senior citizen, single vs. multiple vehicle occupants, etc.).
b. User selects 312 the credit card button next to the customer category.
c. The credit card is swiped 322 on a magnetic stripe reader on the printer and sent to the device Hi over Bluetooth connection 318.
d. The credit card processor 324 is contacted directly from the device Hi.
e. If the transaction is successful 326, the information is stored on the device's local database 302 and a ticket is printed 316 via over Bluetooth connection to printer Pi. If not successful, then an error message 328 is displayed.
f. If the lot is gated and the transaction is successful, the gate is lifted 320.
g. No connection is made with a local or the central server.

Data Synchronization
i. Transaction data from the local storage 302 on the devices Hi are synchronized at remote central server 102 via the transaction 104 at configurable times, and available for report format access in the administrative program 106 via the administrator computer 202 and web site 108.
ii Tickets, user shifts, etc. are sent to the central server through secure communications.
iii Management configuration such as users, settings, rates, etc. originate from the administrator computers 202 but are sent to the devices Hi from the central server 102.
iv. The preferred background processing shown in FIG. 3 can be described from a convenient starting point 330, whereby ticket data that has been synced and is more than some configurable days old, is deleted from the device Hi. The device is configured to send 332 any unsynced tickets, events, errors and the like from its local data storage 302 through the cloud to the server 102 via a web service. A web service is a common way to transfer data using internet protocols, generally in XML formal (extensible markup language). At 334, the device Hi confirms that the server acknowledged successful receipt of the data. If not, an error is logged at 336 and the device Hi “sleeps” 338 for some configurable amount of time before restarting the process at 330. If the synchronization with the server 102 was successful, the device Hi marks the data that was sent, as synced 340. Preferably with the same configured time intervals as used for synchronizing transaction data, the device Hi also queries 342 the server 102 as to whether any configuration changes are to be made such as change of facility, passes, rates, or the like, which were initiated by the administrator 200 via the web access 108 to the remote server. If so, the configuration changes 344 since the last synchronization are downloaded via the same web service that was used to synchronize the transaction data. The device Hi checks 346 as to whether the configuration data was successfully received. If not, an error is logged at 348, the device sleeps for a configurable amount of time 338 and the cycle is repeated. If the configuration data was successfully received, the last sync time is set to the current time 350 and the device Hi sleeps for the configured period of time. It can thus be appreciated that both the transfer of transaction data to the central server 102 and the reconfiguration of the devices Hi as requested by the administrator (or as may be updated by the service provider 100) are batch processes performed at configurable time intervals.

Variations
i. The reason for the wireless connection is to provide freedom from the printer. If it were integral (e.g., tethered), the attendant would need to be aware of the handheld, printer, and cable at all times. The printer can stay in the toll booth while the attendant is outside at the vehicle or the attendant can leave the printer on a belt clip. Integrating the devices is also a possibility, but preferably a credit card swipe application is attached to the handheld, whereas the printer is detached.
ii. In one scenario a car pulls up that has a parking pass as a sticker on the car's windshield. The attendant can step out of the booth, leaving the printer there, scan the pass and let the car through. If another car purchases a one-time use ticket using say, a credit card, the attendant will take the card into the booth, swipe it, take the printed ticket and hand both to the customer.
iii. In another the attendants has the printer with card swipe application attached to his or her belt on a clip. This leaves a free hand for swiping cards. So, a customer pulls up, the attendant clicks on the handheld to select what kind of ticket—automobile, van, truck, in state, out of state, multiple occupant, senior citizen etc., accepts the cash, prints a parking ticket and hands it back, along with the change, to the customer. Or the attendant swipes a card on the printer attached to the belt, the card information is wirelessly transmitted to the hand held device for processing and then returned with the printed ticket to the customer.
iv. Although in the preferred embodiment as described above, each device Hi is configured to initiate the transfer of transaction data to the central server and query the central server as to whether a configuration change is needed and, when needed, receive the configuration changes wirelessly directly from the remote server. This is not absolutely necessary. For example, the central server could initiate the request to the device Hi, for uploading a batch of transaction data on a schedule set by the service provider. Similarly, the schedule for downloading configuration changes to the devices Hi, could be set for a regular interval, or on an ad-hoc basis as needed. As yet another alternative, the configuration changes could be a separate process from the transaction synchronization. Instead of a configuration change being delivered directly over a global communications network to the device Hi, it could be delivered to the administrative computer 202 (or any other designated computer), wi8th the requirement that the device Hi receive the configuration change through the local computer, either through a USB connection or any wireless communication.

5. Preferred Hardware
a. The commercial names of the presently preferred kinds of hand-helds that are suitable include Intermec CN50, CS40, CN70 and Motorola MC70, MC75.
b. The commercial names of the preferred printer/card readers include Intermec PB21.
c. The programming languages that are preferred for programming the handhelds include Net Compact Framework using C#; the central (cloud) server ASP.Net Web Service using C#.
d. The administrator's computer can be any computer that has an Internet connection.
e. Optionally, a computer can be provided at each parking location for the site manager to access the service provider's web site at the central computer via the Internet and view report about that site.
f. The system could be implemented with different kinds of input devices that are not necessarily hand-held, but with the same functionality and architecture. The system application could be run on a desktop, laptop, netbook or tablet. The implementing software can be hardware-independent. For a tablet embodiment the machine would sit in the toll booth and a Bluetooth barcode scanner used for any necessary scanning of a parking tag, but the printer/credit card swipe would remain the same.

6. Other Technical
The navigation in the present system is circular, with all forms as displayed on the hand held devices created from the beginning and waiting to be used. When the attendant clicks a button, a form is displayed. If they go back, they return to the original form, rather than opening a new one.
Polymorphism and inheritance techniques permit easy addition of printer models and credit card swipe machines.
Events such as lifting gates and printing are done asynchronously, which means they occur at the same time but on different processor threads.

1. A system for an administrator to financially manage the parking of vehicles at a parking location where an attendant records toll transactions with a portable wireless device at a toll portal, comprising:
(a) a central computer processing server that is remote from the location;
(b) at least one portable device which
(i) accepts manually entered input data associated with at least one vehicle category,
(ii) includes a database of price data associated with each category,
(iii) includes a processor responsive to the input data and the price database for generating print instructions for a ticket showing the amount of the toll transaction,
(iv) includes memory where data for each of a plurality of ticket transactions is stored,
(v) includes a wireless communication module for simultaneously transmitting data in the memory for a plurality of ticket transactions to a transaction program in the remote server over a connection to a global communications network; and
(c) an administrative computer connectable over a global communications network to an administration program in the remote computer, by which the administrator can obtain a report on the transactions from all devices.

2. The system of claim 1, wherein a plurality of attendants having a respective plurality of said wireless devices are at one parking location and the administrator can obtain a report from the remote computer on the transactions from all devices at said parking location.

3. The system of claim 1, wherein a plurality of administrators for a respective plurality of parking locations can obtain a report from the same remote computer on the transactions from all devices at the respective parking locations.

4. The system of claim 3, wherein the remote computer is under the control of a service provider and each administrative computer is connectable to an administration program in the remote computer, through a common web site under the control of the service provider.

5. A system for an administrator to financially manage the parking of vehicles at a location where an attendant records toll transactions with a handheld wireless device at a toll portal, comprising:
(a) a central computer processing server that is remote from the location;
(b) at least one hand held device which
(i) accepts manually entered input data including at least one of (1) type of vehicle, (2) type of vehicle driver, (3) number of vehicle occupants, and (4) area within the location where the vehicle is authorized to park,
(ii) includes a rate database of rate data associated with a respective at least one of the input data of (b)(i),
(iii) includes a processor responsive to the input data of (b)(i) and the rate database of (b)(ii) for generating print instructions for a ticket showing the amount of the toll transaction,
(iv) includes a cache memory where transaction data for each of a plurality of ticket transactions is stored,
(v) includes a wireless communication module for transmitting the transaction data in the cache memory to a transaction program in the remote server over a connection to a global communications network; and
(c) an administrative computer connectable over a global communications network to an administration program in the remote computer, by which the administrator can obtain a report on the transactions over a selected period of time.

6. The system of claim 5, wherein the connection of the administrative computer over said global communications network to said administration program in the remote computer includes an interface whereby the administrator instructs the central computer to communicate over a global communications network with a plurality of other hand held devices and thereby enable said other handheld devices to be used at said location according to (b)(i)-(v).

7. The system of claim 5, wherein the connection of the administrative computer over said global communications network to said administration program in the remote computer includes an interface whereby the administrator instructs the central computer to communicate over a global communications network with a plurality of other hand held devices and thereby enables any of a plurality of said other handheld devices to be used at any other location according to (b)(i)-(v).

8. The system of claim 5, wherein the connection of the administrative computer over said global communications network to said administration program in the remote computer includes an interface whereby the administrator instructs the central computer to communicate over a global communications network to configure rate data in the rate database of any of said at least one hand held devices.

9. The system of claim 5, wherein the connection of the administrative computer over said global communications network to said administration program in the remote computer includes an interface whereby the administrator instructs the central computer to communicate over a global communications network to
enable additional handheld devices to be used at said location according to (b)(i)-(v);
enable any handheld device to be used at any other location according to (b)(i)-(v); and
configure rate data in the rate database of any of said at least one hand held devices.

10. The system of claim 5, wherein the central computer is connectable simultaneously over a global communications network to a plurality of administrative computers.

11. The system of claim 9, wherein the central computer is connectable simultaneously over a global communications network to a plurality of administrative computers.

12. The system of claim 10, wherein the administrative computer is connectable over a global communications network to the administration program in the remote computer through a web site under the control of a service provider.

13. The system of claim 9, wherein said interface is a web site under the control of a service provider.

14. The system of claim 11, wherein said interface is a web site under the control of a service provider.

15. The system of claim 9, comprising a plurality of said administrator computers;
a plurality of said hand held devices associated with each administrative computer; and
a printer associated with each hand held device.

16. The system of claim 5, comprising a plurality administrators, with each administrator having responsibility for a plurality parking locations;
a plurality of portals at each location;
a hand-held device located at each portal;
an administrative computer for each administrator, connectable over a global communications network to the administration program in the remote computer through a web site under the control of a service provider;
wherein through the web site connection, each administrator can instruct the central computer to communicate over a global communications network with the plurality of hand held devices and thereby
enable additional hand held devices to be used according to (b)(i)-(v) at of the respective locations for which each administrator is responsible,
enable any hand held device used in one location for which the administrator is responsible to be used according to (b)(i)-(v) at any other location for which the administrator is responsible, and
configure rate data in the rate database of all the hand held devices at any location for which the administrator is responsible.

17. A process by which an administrator financially manages the parking of vehicles at a location where an attendant records toll transactions with a portable wireless device at a toll portal, comprising:
(a) manually entering input data associated with at least one vehicle category into the portable device when each vehicle approaches the toll portal;
(b) in the device, processing the input data in relation to a rate database stored in the device, to generate print instructions for a ticket showing the amount of the toll transaction;
(c) in the device, storing transaction data for each of a plurality of toll transactions;
(d) transmitting a batch of toll transaction data from the device to a remote central computer server over a connection to a global communications network; and
(e) in the remote computer, generating transaction reports from the toll transaction data and delivering the reports to an administrative computer over the global communications network.

18. The process of claim 17, wherein the rate database is modified by a digital transmission from the remote central server to the device.

19. The process of claim 18, wherein the administrator transmits a request for modification of the rate database to the remote central server over a connection to a global communications network and in response to said request the rate database in the device is modified by said digital transmission from the remote central server to the device.

20. The process of claim 19, wherein
on a preset schedule the device periodically initiates data communication with the remote central server over a connection to a global communications network;
during each said communication
the device transmits a batch of toll transaction data to the remote central computer server over said connection to a global communications network,
at least one of the device and remote central computer determine whether a new modification to the rate database is pending, and
if a new modification to the rate database is pending the rate database in the device is modified by said digital transmission from the remote central server to the device.

21. The process of claim 20, wherein the administrator receives said reports and requests modification of the rate database, by a web site interface with the remote central server.

22. The process of claim 17, wherein an administrator using an administrator computer communicates with the central computer to obtain digital instructions from the central computer by which the administrator can enable hand held devices to perform the operations (a)-(e).
